(19) United States
(12) Patent Application Publication
(10) Pub. No.: US 2009/0007384 A1
(43) Pub. Date: Jan. 8, 2009

(54) Hinge with an overridable limiting function

(75) Inventor: Tzu-Yu Lin, Shulin City (TW)

Correspondence Address: COOPER & DUNHAM, LLP, 1185 AVENUE OF THE AMERICAS, NEW YORK, NY, 10036, US

(73) Assignee: Shin Zu Shing Co., Ltd.

(21) Appl. No.: 11/825,399

(22) Filed: Jul. 6, 2007

(51) Int. Cl. E05D 11/06

(52) U.S. Cl. 16/375; 16/380; 16/386

(57) ABSTRACT

A hinge with an overridable limiting function is mounted in an electronic device with a cover and a base and has a pintle, a stationary leaf and a rotating assembly. The pintle has a limit. The stationary leaf is mounted securely on the pintle and is mounted securely in the base. The rotating assembly is mounted around the pintle, is mounted securely in the cover and has at least one positive stop. The positive stop has an inside surface and an inner part selectively abutting the limit of the pintle to provide a limiting function. When a person applies excessive force to the cover and over-pivots the cover, the positive stop is bent out and the inside surface of the positive stop slides along the limit. The outward bending of the positive stop absorbs the excessive force to keep the cover from being damaged.

### BACKGROUND OF THE INVENTION

1. Field of the Invention

The present invention relates to a hinge, especially to a hinge with an overridable limiting function when excessive force is applied to the hinge.

2. Description of the Prior Arts

Electronic devices such as notebook computers, cell phones, etc. have a cover, a base and a conventional hinge. The conventional hinge connects the cover to the base along a transverse axis to allow the cover to pivot relative to the base. The conventional hinge usually has a limiting function to stop the conventional hinge from pivoting when the cover is fully opened and closed.

With reference to FIG. 8, a conventional limiting hinge comprises a pintle (60), a stationary leaf and a pivoting assembly (70). The pintle (60) has a limit (61) formed transversely on the pintle (60). The stationary leaf is attached to the pintle (60) and is mounted securely in the base. The pivoting assembly (70) comprises a pivoting leaf and a barrel (71). The pivoting leaf is mounted securely in the cover and has a proximal edge. The barrel (71) is formed on the proximal edge of the pivoting leaf and has a slot and a positive stop (710). The slot is formed through the barrel (71), is mounted around the limit (61) and has two sidewalls. The positive stop (710) is formed on one of the sidewalls of the slot and selectively abuts the limit (61) to provide a limiting function.

However, if a person exerts more force to pivot the hinge when the positive stop (710) has already abutted the limit 61), the cover is easily broken by the excessive force.

To overcome the shortcomings, the present invention provides a hinge with an overridable limiting function to mitigate or obviate the aforementioned problems.

### SUMMARY OF THE INVENTION

The main objective of the present invention is to provide a hinge with an overridable limiting function when an excessive force is applied to the limiting hinge.

A hinge with an overridable limiting function in accordance with the present invention is mounted in an electronic device with a cover and a base and has a pintle, a stationary leaf and a rotating assembly. The pintle has a limit with an outside edge. The stationary leaf is mounted securely on the pintle and is mounted securely in the base. The rotating assembly is mounted around the pintle, is mounted securely in the cover and has at least one positive stop. The positive stop has an inside surface and an inner part selectively abutting the limit of the pintle to provide a limiting function. When a person applies an excessive force to the cover to excessively pivot the cover, the positive stop is bent out and the inside surface of the positive stop slides along the outside edge of the limit. The outward bending of the positive stop absorbs the excessive force to keep the cover from being damaged.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge with an overridable limiting function in accordance with the present invention;

FIG. 2 is a perspective view of the hinge in FIG. 1;

FIG. 3 is an end view in partial section of the hinge in FIG. 1;

FIG. 4 is an operational end view in partial section of the hinge in FIG. 1;

FIG. 5 is an exploded perspective view of another embodiment of a hinge with an overridable limiting function in accordance with the present invention;

FIG. 6 is an end view in partial section of the hinge in FIG. 5;

FIG. 7 is an operational end view in partial section of the hinge in FIG. 5; and

FIG. 8 is a perspective view of a conventional hinge with a limiting function in accordance with the prior art.

### DETAILED DESCRIPTION OF THE PREFERRED EMBODIMENTS

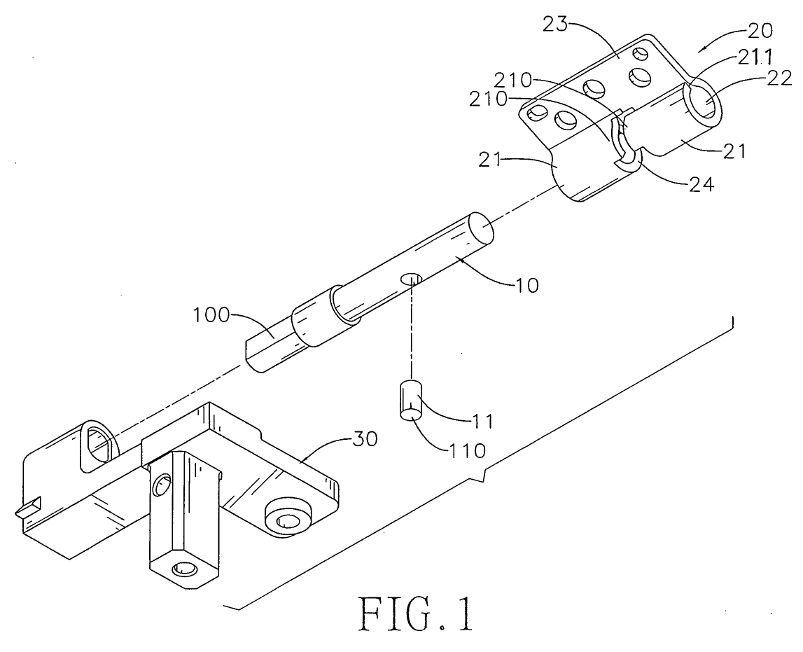

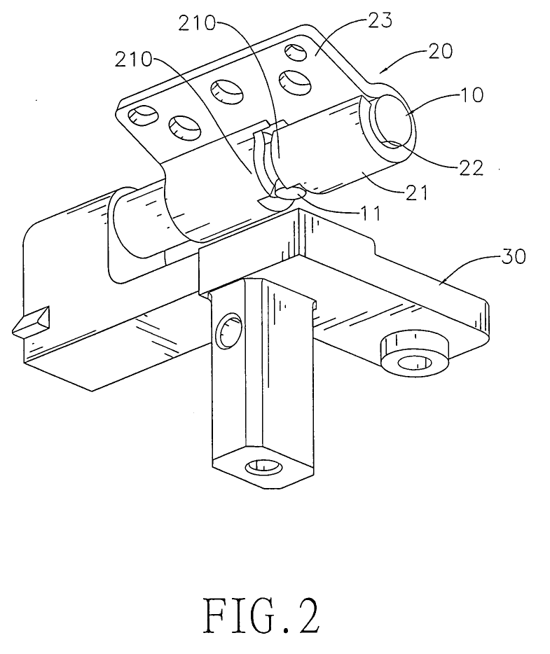

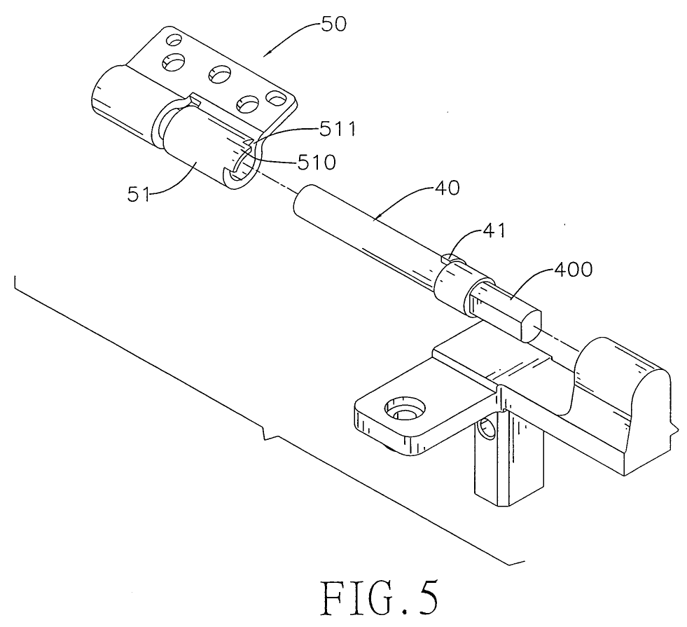

With reference to FIGS. 1, 2 and 5, a hinge with an overridable limiting function in accordance with the present invention is mounted in an electronic device having a cover and a base and comprises a pintle (10, 40), a stationary leaf (30) and a rotating assembly (20, 50).

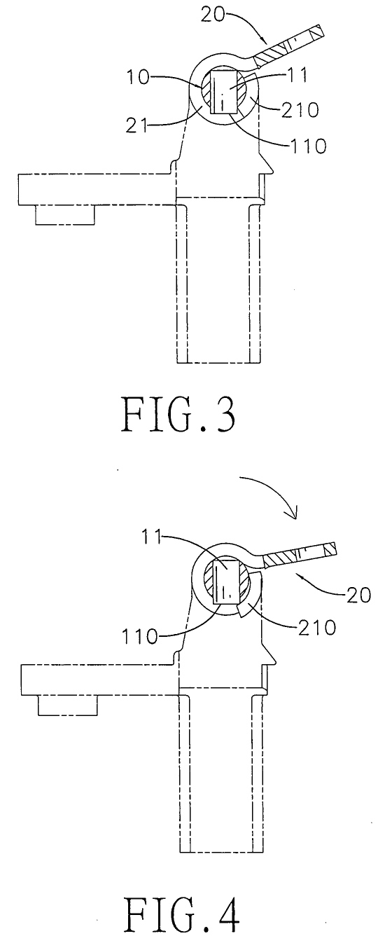

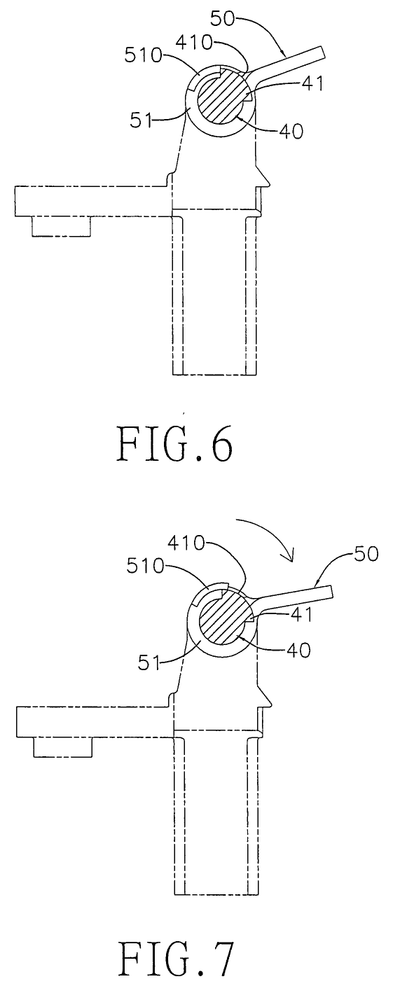

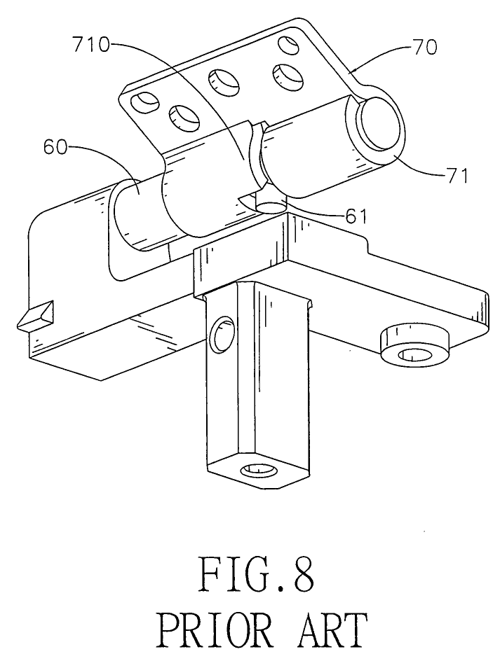

With further reference to FIGS. 3 and 6, the pintle (10, 40) has a mounting end (100, 400), a pivoting end and a limit (11, 41). The pivot end has an outside surface. The limit (11, 41) may be a pin limit (11) or a curved limit (41), is formed transversely on the pivoting end and has an outer edge (110, 410) and a protruding distance. The protruding distance is formed between the outer edge (110, 410) of the limit (11, 41) and the outside surface of the pivot end of the pintle (10, 40).

The stationary leaf (30) is mounted securely on the mounting end (100, 400) of the pintle (10, 40) and is mounted securely in the base of the electronic device.

The rotating assembly (20, 50) connects to the pivot end of the pintle (10, 40) and has a pivoting leaf (23, 53) and a barrel (21, 51). The pivoting leaf (23, 53) is mounted securely in the cover of the electronic device and has a proximal edge. The barrel (21, 51) is formed longitudinally on the proximal edge of the pivoting leaf (23, 53), is slightly resilient, is mounted around the pivoting end of the pintle (10, 40) and has a pivot hole (22, 52), at least one longitudinal slot (211, 511), an inside surface, an outside surface, an optional abutting end, an optional transverse slot (24) and at least one positive stop (210, 510). The pivot hole (22, 52) is formed coaxially through the barrel (21, 51) and is mounted around the pivoting end of the pintle (10, 40). The at least one longitudinal slot (211, 511) is formed through the barrel (21, 51). The inside surface of the barrel (21, 51) abuts the outside surface of the pivoting end of the pintle (20, 50). The abutting end corresponds to the limit (11, 41) of the pintle (10, 40). The transverse slot (24) is formed transversely in the barrel (21), communicates with the pivot hole (22, 52), is mounted around the pin limit (11) and has two sidewalls. The at least one positive stop (210, 510) is formed on the barrel (21, 51) and has an outside surface, an inside surface, an outer part, an inner part and a thickness. The outside surface of the at least one positive stop (210, 510) aligns with the outside surface of the barrel (21, 51). The inside surface of the at least one positive stop (210) may align with the inside surface of the barrel (21). The inner part selectively abuts the limit (11, 41) of the pintle (10, 40). The thickness is a perpendicular distance between the outside and inside surfaces of the at least one positive stop (210, 510) and may be larger or smaller than the protruding distance of the limit (11, 41). The barrel (21, 51) may have two positive stops (210) opposite to each other or a single positive stop (510). The two opposite positive stops (210) are formed longitudinally respectively on the sidewalls of the slot (24). The single positive stop (510) is formed longitudinally on the abutting end of the barrel (51).

When a person applies a normal force to the cover of the electronic device to pivot the cover, the cover stops rotating when the inner part of the positive stop (210, 510) abuts the limit (11, 41).

With further reference to FIGS. 4 and 7, when a person applies an excessive force to the cover to over pivot the cover, the positive stop (210, 510) is bent out, and the inside surface of the positive stop (210, 510) slides along the outside edge (110, 410) of the limit (11, 41). The outward bending of the positive stop (210, 510) absorbs the excessive force to keep the cover from being damages. Furthermore, when a person pivots the cover back, the positive stop (210, 510) is repositioned, and the limit (11, 41) and the positive stop (210, 510) still provide the limiting function.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge with an overridable limiting function comprising:
a pintle having
a mounting end;
a pivoting end having an outside surface; and
a limit being formed transversely on the pivoting end and having
an outer edge; and
a protruding distance being formed between the outer edge or the limit and the outer surface of the pivot end of the pintle;
a stationary leaf being mounted securely on the mounting end of the pintle; and
a rotating assembly connecting to the pivot end of the pintle and having
a pivoting leaf having a proximal edge; and
a barrel being slightly resilient, being formed longitudinally on the proximal edge of the pivoting leaf, being mounted around the pivoting end of the pintle and having
a pivot hole being formed coaxially through the barrel and being mounted around the pivoting end of the pintle;
an inside surface abutting the outside surface of the pivoting end of the pintle;
an outside surface; and
a longitudinal slot formed through the barrel;
at least one positive stop being formed on the barrel, and each one of the at least one positive stop having
an outside surface aligning with the outside surface of the barrel;
an inside surface;
an outer part; and
an inner part selectively abutting the limit of the pintle.

2. The hinge as claimed in claim 1, wherein the limit of the pintle is a pin limit.

3. The hinge as claimed in claim 1, wherein the limit of the pintle is a curved limit.

4. The hinge as claimed in claim 1, wherein
the inside surface of each one of the at least one positive stop aligns with the inside surface of the barrel; and
each one of the at least one positive stop further has a thickness being a perpendicular distance between the outside and inside surfaces of the at least one positive stop and being larger than the protruding distance of the limit.

5. The voidable limiting hinge as claimed in claim 2, wherein
the inside surface of each one of the at least one positive stop aligns with the inside surface of the barrel; and
each one of the at least one positive stop has a thickness being a perpendicular distance between the outside and inside surfaces of the at least one positive stop and being larger than the protruding distance of the limit.

6. The voidable limiting hinge as claimed in claim 3, wherein
the inside surface of each one of the at least one positive stop aligns with the inside surface of the barrel; and
each one of the at least one positive stop has a thickness being a perpendicular distance between the outside and inside surfaces of the at least one positive stop and being larger than the protruding distance of the limit.

7. The voidable limiting hinge as claimed in claim 1, wherein each one of the at least one positive stop has a thickness being a perpendicular distance between the outside and inside surfaces of the at least one positive stop and being smaller than the protruding distance of the limit.

8. The hinge as claimed in claim 2, wherein each one of the at least one positive stop has a thickness being a perpendicular distance between the outside and inside surfaces of the at least one positive stop and being smaller than the protruding distance of the limit.

9. The voidable limiting hinge as claimed in claim 3, wherein each one of the at least one positive stop has a thickness being a perpendicular distance between the outside and inside surfaces of the at least one positive stop and being smaller than the protruding distance of the limit.

10. The hinge as claimed in claim 2, wherein the barrel further has a transverse slot formed transversely in the barrel, communicating with the pivot hole and mounted around the pin limit.

11. The hinge as claimed in claim 10, wherein
the transverse slot in the barrel has two sidewalls; and
the barrel has two positive stops formed longitudinally respectively on the sidewalls of the transverse slot.

12. The hinge as claimed in claim 3, wherein the barrel has
an abutting end corresponding to the limit; and
one positive stop formed longitudinally on the abutting end of the barrel.
